(19) United States
(12) Patent Application Publication
(10) Pub. No.: US 2024/0310646 A1
(43) Pub. Date: Sep. 19, 2024

(54) Tunable Anti-Glare Filter

(71) Applicant: Illinois Tool Works Inc., Glenview, IL (US)

(72) Inventors: Jiafu Fang, Spring, TX (US); Sarah Edwards Wagner, Houston, TX (US)

(21) Appl. No.: 18/584,067

(22) Filed: Feb. 22, 2024

Related U.S. Application Data
(60) Provisional application No. 63/452,241, filed on Mar. 15, 2023.

(51) Int. Cl. G02B 27/28; B60J 3/02; B60J 3/04

(52) U.S. Cl. CPC G02B 27/281; B60J 3/0204; B60J 3/04

(57) ABSTRACT

A tunable anti-glare filter for adjusting an intensity of light passing through the tunable anti-glare filter and into a vehicle. The tunable anti-glare filter having a first polarized filter layer and a second polarized filter layer. The first polarized filter layer is configured to rotate about a center axis relative to a substrate. The second polarized filter layer is substantially parallel to the first polarized filter layer and is fixed relative to the substrate. The first polarized filter layer is configured to rotate between a first extreme position and a second extreme position that is shifted 90 degrees about the center axis.

### RELATED APPLICATION

The present application claims priority to U.S. Provisional Patent Application No. 63/452,241, filed Mar. 15, 2023, and entitled “Tunable Anti-Glare Filter” which is hereby incorporated by reference in its entirety.

### BACKGROUND

Vehicle operators (e.g., drivers, captains, pilots, and the like) inevitably encounter situations where glare impairs the operator's vision to various degrees. The source of the glare can be the sun, high beams of an on-coming vehicle, reflection of light from a building's glazing surfaces, or even from the shining surfaces of vehicles ahead of the vehicle. In an extreme case, the glare can be so severe that the operator cannot see with certainty what lies in front of the vehicle, greatly endangering the safety of the occupants and cargo of the vehicle or people and property in the immediate surroundings. In fact, repeated consumer surveys show that glare is a pain-point for the operator of a vehicle.

Modern-day vehicles are often equipped with a sun visor for the operator, which attempts to improve the operator's vision by blocking a portion in the field of view associated with the source of the glare. However, in some situations, the sun visor has to be positioned such that only a small portion of field of vision remains for the operator to see through glass components of the vehicle (e.g., a windshield), which greatly limits the visibility. Similarly, some vehicles can be equipped with a tinted visor shade that attached to the vehicle (e.g., by clipping) onto the sun visor; however, the degree of tint cannot be adjusted.

Despite advancements to date, a need exists for a more effective way to address the aforementioned glare such that an operator of a vehicle can better perform when faced with a glare condition.

### SUMMARY

The present disclosure relates generally to a tunable anti-glare filter, substantially as illustrated by and described in connection with at least one of the figures, as set forth more completely in the claims. More specifically, the present disclosure relates to a tunable anti-glare filter that enables the operator to adjust the intensity of light passing through the tunable anti-glare filter.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates an example vehicle having a windshield and two tunable anti-glare filters.

FIG. 2a illustrates a perspective view of a tunable anti-glare filter in accordance with an aspect of the present disclosure.

FIG. 2b illustrates an assembly view of the tunable anti-glare filter.

FIG. 2c illustrates a cross-sectional view of the tunable anti-glare filter taken along cutline A-A (FIG. 2a).

FIGS. 3a through 3d illustrate the tunable anti-glare filter during transition from a first extreme position to a second extreme position.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a tunable anti-glare filter, more particularly, a tunable anti-glare filter that enables the operator to adjust the intensity of light passing through the tunable anti-glare filter. While the subject disclosure will be described primarily in connection with automobiles, other vehicles and activities can suffer from the same glare issues. Therefore, the following disclosure should not be limited to use in automobiles, but rather would be applicable to any type of vehicle, such as motorcycles, trains, watercraft, and aircraft.

In one example, a tunable anti-glare filter for adjusting an intensity of light passing through the tunable anti-glare filter and into a vehicle comprises a first polarized filter layer and a second polarized filter layer. The first polarized filter layer is configured to rotate about a center axis relative to a substrate. The second polarized filter layer is substantially parallel to the first polarized filter layer and is fixed relative to the substrate. The first polarized filter layer is configured to rotate between a first extreme position and a second extreme position that is shifted 90 degrees about the center axis.

In another example, a tunable anti-glare filter for adjusting an intensity of light passing through the tunable anti-glare filter comprises: a first polarized filter layer configured to rotate about a center axis relative to a substrate; and a second polarized filter layer that is substantially parallel to the first polarized filter layer and that is fixed relative to the substrate, wherein the first polarized filter layer configured to rotate about the center axis between a first extreme position where the intensity of the light passing through the first polarized filter layer and the second polarized filter layer is substantially unobstructed, and a second extreme position where the intensity of the light passing through the first polarized filter layer and the second polarized filter layer is substantially blocked.

In yet another example, a tunable anti-glare filter for adjusting an intensity of light passing through the tunable anti-glare filter comprises: a first polarized filter layer configured to rotate about a center axis relative to a substrate; and a second polarized filter layer that is substantially parallel to the first polarized filter layer and that is fixed relative to the substrate, wherein the first polarized filter layer configured to rotate about the center axis between a first extreme position where the intensity of the light passing through the first polarized filter layer and the second polarized filter layer is substantially unobstructed, and a second extreme position where the intensity of the light passing through the first polarized filter layer and the second polarized filter layer is substantially blocked, and wherein the first extreme position and the second extreme position are shifted 90 degrees about the center axis.

In some examples, in the first extreme position, the intensity of the light passing through the first polarized filter layer and the second polarized filter layer is substantially unobstructed, while, in the second extreme position, the intensity of the light passing through the first polarized filter layer and the second polarized filter layer is substantially blocked.

In some examples, the tunable anti-glare filter further comprises a retaining ring. The second polarized filter layer can be fixedly coupled to the substrate via the retaining ring. The second polarized filter layer, the substrate, and the retaining ring can define a cavity. The first polarized filter layer can be positioned within the cavity.

In some examples, the tunable anti-glare filter further comprises a dial tab configured to pass through a dial slot formed in the second polarized filter layer. The dial slot can be an arcuate slot that has an arc length of 90 degrees.

In some examples, the substrate is a layer of clear, rigid material. The substrate may include one or more fasteners to couple the tunable anti-glare filter to the vehicle. In another example, the substrate is a glass component of the vehicle.

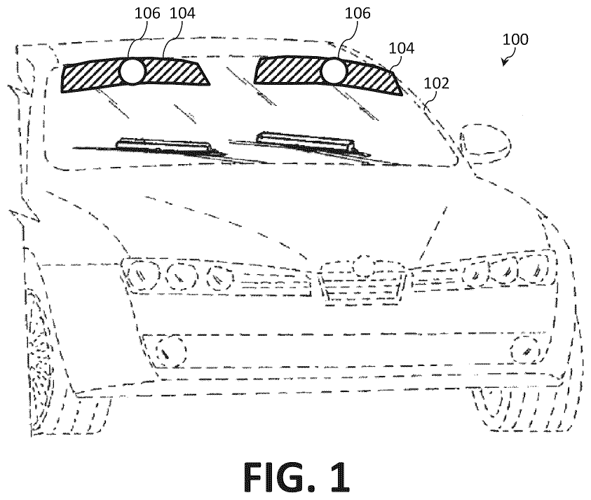

FIG. 1a illustrates an example vehicle 100 having a windshield 102 and a pair of sun visors 104. The pair of sun visors 104 are pivotally coupled within the vehicle 100 to the upper edge of the windshield frame. As is known in the art, each of the pair of sun visors 104 can be configured to detach at one end and to swing about a pivot point at the a-pillar to selectively block a portion of either the windshield 102 or the side glass (e.g., the front door window(s)).

As illustrated, in accordance with an aspect of the present disclosure, each of the pair of sun visors 104 includes a tunable anti-glare filter 106. In this example, each of the tunable anti-glare filters 106 is integrated into a sun visor 104. In operation, the operator could swing one or both sun visors 104 downward or to the side (i.e., to block a portion of the windshield 102 or the side glass), while still being able to view the area surrounding the vehicle 100 through the tunable anti-glare filter 106.

While illustrated as being integrated with the sun visors 104, the tunable anti-glare filter 106 can be configured as a separate component. For example, as an aftermarket accessory. In one example, the tunable anti-glare filter 106 could be configured to clip onto a sun visor 104 via one or more fasteners and to pivot down when needed. In another example, the tunable anti-glare filter 106 can be attached to, or even integrated with, a glass component of the vehicle 100, whether the windshield 102, the door glass of the vehicle 100, or mirror glass (e.g., the rearview mirror, side mirrors, etc.). The tunable anti-glare filter 106 can attached to a glass component of the vehicle 100 via, for example, suction cups, adhesives, tapes (e.g., double-sided tape), and the like. In addition, multiple tunable anti-glare filter 106 can be located within the vehicle 100 such that multiple occupants can benefit from the tunable anti-glare filter 106 with increased comfort level.

Further, in some examples, such as where it would be impractical to attach the tunable anti-glare filter 106 to a vehicle 100, the tunable anti-glare filter 106 could be integrated with the operator's apparel. For example, in the case of a motorcycle, it may be difficult to attach the tunable anti-glare filter 106 to the motorcycle's windshield; therefore, the tunable anti-glare filter 106 could be attached to or integrated with the operator's headwear (e.g., helmets, hats, caps, etc.) or eyewear (e.g., goggles, glasses, etc.).

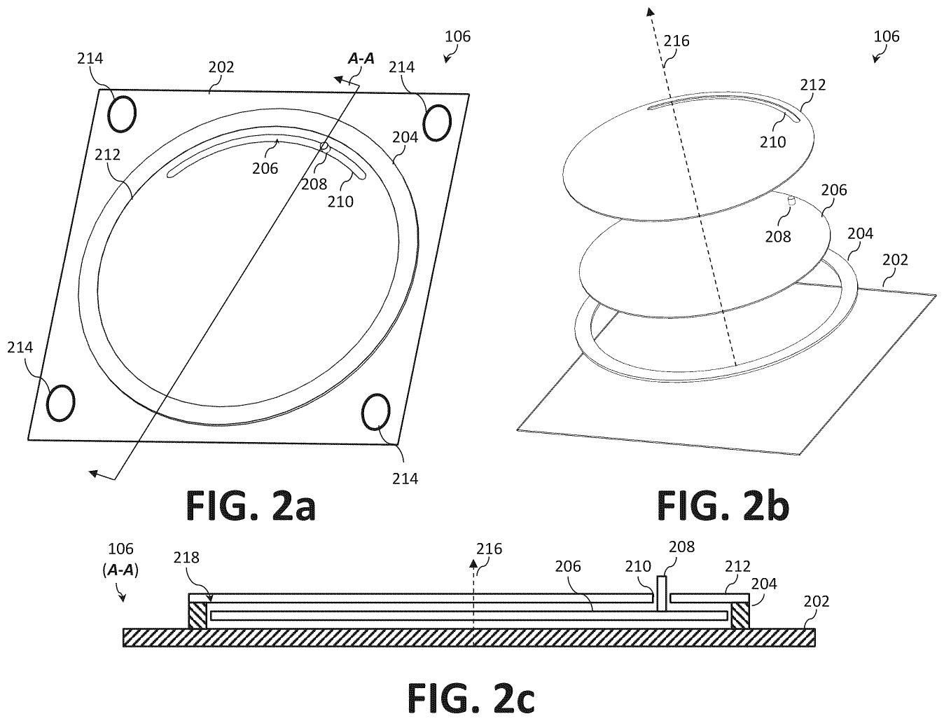

FIG. 2a illustrates a perspective view of a tunable anti-glare filter 106 in accordance with an aspect of the present disclosure, while FIG. 2b illustrates an assembly view of the tunable anti-glare filter 106. FIG. 2c illustrates a cross-sectional view of the tunable anti-glare filter 106 taken along cutline A-A of FIG. 2a. As illustrated, the tunable anti-glare filter 106 generally comprises or uses a substrate 202, a first polarized filter layer 206, and a second polarized filter layer 212. As will be discussed, the first polarized filter layer 206 is configured to rotate relative to the second polarized filter layer 212 about the center axis 216 to adjust an intensity of light passing through the tunable anti-glare filter 106 (i.e., through the first polarized filter layer 206 and the second polarized filter layer 212). To that end, the tunable anti-glare filter 106 may further comprise a retaining ring 204, a dial tab 208, and a dial slot 210.

The substrate 202 can be, for example, a layer of clear, rigid material (e.g., glass, plexiglass, etc.) to provide structural support and rigidity to the tunable anti-glare filter 106. For example, the tunable anti-glare filter 106 can be attached to the vehicle 100 via the substrate 202, which may further include one or more fasteners 214, such as suction cups, hook and loop fastener tape (e.g., Velcro®), adhesives, tapes (e.g., double-sided tape), and the like. In examples where the tunable anti-glare filter 106 is integral with the vehicle 100 (or component thereof), the substrate 202 can be omitted and the structural support and rigidity function can be provided by the vehicle or the component of the vehicle. For example, where the tunable anti-glare filter 106 is integral with a glass component of the vehicle 100, that glass component could serve as the substrate 202.

In the illustrated example, the first polarized filter layer 206 and the second polarized filter layer 212 are each provided in the form of circular disks that are concentric and parallel to one another. The first polarized filter layer 206 and the second polarized filter layer 212 can be fabricated from the same material, such as a polaroid filter material that produces a high degree of plane polarization in light passing through it. For example, the first polarized filter layer 206 and the second polarized filter layer 212 may each be a thin, plastic polarizing sheet or film. In examples where increased rigidity is desired, the first polarized filter layer 206 and the second polarized filter layer 212 may each be composed of a thin polarizing film adhered to a clear backing. In some examples, the first polarized filter layer 206 and the second polarized filter layer 212 are substantially identical, apart from, for example, use of dial tabs 208 or the dial slots 210, and the diameter (accounting for the retaining ring 204).

In operation, each of the first polarized filter layer 206 and the second polarized filter layer 212 absorbs one component of polarization, while transmitting the perpendicular components. The intensity of light transmitted, therefore, depends on the relative orientation between the polarization direction of the incoming light and the polarization axis of the first polarized filter layer 206 and/or the second polarized filter layer 212. In the illustrated example, the first polarized filter layer 206 is configured to freely rotate relative to the substrate 202 about the center axis 216, while the second polarized filter layer 212 is fixed relative to the substrate 202. The relationship between the incoming light vis-a-vis the first polarized filter layer 206 and the second polarized filter layer 212 can be further described using Malus' Law.

In one example, as best illustrated in FIG. 2c, the second polarized filter layer 212 is fixedly coupled to the substrate 202 via the retaining ring 204. The second polarized filter layer 212 can be coupled to the substrate 202 via the retaining ring 204 using an adhesive, but other attachment techniques are contemplated, including, for example, ultrasonic welding, pins, screws, etc. The combination of the second polarized filter layer 212, the substrate 202, and the retaining ring 204, in effect, define a cavity 218.

As illustrated, the first polarized filter layer 206 can be positioned within the cavity 218. The first polarized filter layer 206 further comprises a dial tab 208 extending generally perpendicularly from a plane defined by the first polarized filter layer 206 and through the dial slot 210 formed in the second polarized filter layer 212. As illustrated, the dial slot 210 can be an arcuate slot that ends 90 degrees about the center axis 216 (i.e., has an arc length of 90 degrees). Once assembled, the operator can rotate the first polarized filter layer 206 within the cavity 218 via the dial tab 208 between a first extreme position to a second extreme position that is shifted 90 degrees about the center axis 216 (as dictated by the arc length of the dial slot 210). Shifting the dial tab 208 thus changes the amount of light transmission by changing the relative orientations between the first polarized filter layer 206 and the second polarized filter layer 212.

The one or more components of the tunable anti-glare filter 106 can be fabricated metal or a plastic material (e.g., via a plastic injection process). In some examples, one or more components of the tunable anti-glare filter 106 may a printed thermoplastic material component, which can be particularly advantageous, for example, in creating components requiring complex and/or precise features. Additive manufacturing techniques and processes obviate the need for mold tooling typically associated with plastic injection molding, thereby lowering up-front manufacturing costs, which is particularly advantageous in low-volume productions. In some examples, one or more components of the tunable anti-glare filter 106 can be fabricated using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process. In some examples, one or more components of the tunable anti-glare filter 106 may be formed or otherwise fabricated at different resolutions during a printing operation.

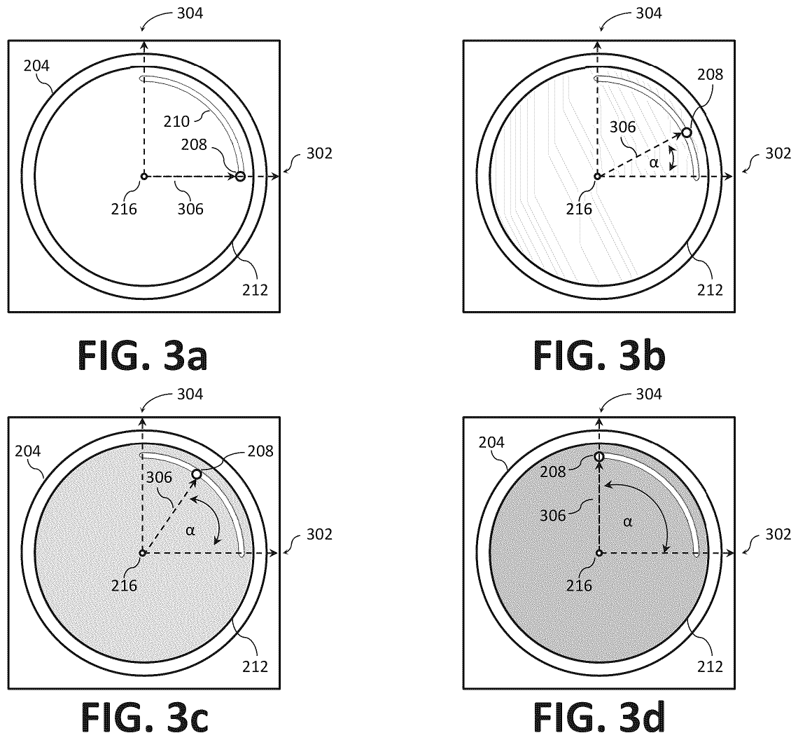

FIGS. 3a through 3d illustrate the tunable anti-glare filter 106 during transition from a first extreme position (FIG. 3a) to a second extreme position (FIG. 3d) that is shifted 90 degrees about the center axis 216. In other worse, as illustrated, one of the films (here, the first polarized filter layer 206) can rotate relative to the other by an angle (α) to allow for fine control of antiglare. In this example, the angle (α) is a user-selectable angle that ranges from 0 to 90 degrees in terms of their light transmission axis. The operator can adjust the angle (α) between 0 and 90 degrees to suit his/her comfort level by sliding the dial tab 208 along the dial slot 210.

Turning to FIG. 3a, where the angle (α) is at or near the zero degrees (a first extreme position), polarized light passing through the combination of the first polarized filter layer 206 and the second polarized filter layer 212 is maximized (i.e., effectively unobstructed). As illustrated, the dial slot 210 includes an arc length that extends from a first axis 302 to a second axis 304 that is perpendicular to the first axis 302. At the first extreme position, the dial tab 208 is positioned in the dial slot 210 at or adjacent the first axis 302 such that a dial vector 306 defined between the center axis 216 and the dial 208 is aligned with and parallel to the first axis 302 (i.e., the angle (α) is substantially 0 degrees). In this position, the transmission of light is maximized (i.e., 100%).

Turning to FIG. 3b, the dial tab 208 is moved along the dial slot 210 (e.g., via the operator) to a first intermediate position. As illustrated, the dial tab 208 is positioned in the dial slot 210 at an intermediate positon that is approximately ⅓ the way to the second extreme position. In this example, the angle (α) is about 30 degrees. In this position, the transmission of light is reduced (e.g., to about 66.66% transmission).

Turning to FIG. 3c, the dial tab 208 is moved further along the dial slot 210 (e.g., via the operator) to a second intermediate position. As illustrated, the dial tab 208 is positioned in the dial slot 210 at an intermediate positon that is approximately ⅔ the way to the second extreme position. In this example, the angle (α) is about 60 degrees. In this position, the transmission of light is reduced (e.g., to about 33.33% transmission).

Turning to FIG. 3d, the dial tab 208 is moved further along the dial slot 210 (e.g., via the operator). As illustrated, the dial tab 208 is positioned in the dial slot 210 at the second extreme position. In this example, the angle (α) is about 90 degrees. In this second extreme position, the transmission of light passing through the films is minimized (i.e., substantially blocked, to about 0% transmission).

The illustrated dial slot 210 enables the operator to select any angle (α) between about 0 and about 90 degrees. Additionally or alternatively, the dial slot 210 can include one or more features along the arc length that restrict the operator to one or more positions. For example, detent features could be positioned at set increments (e.g., every “x” degrees, where x is equal to 2, 5, 10, etc.), which could further mitigate slippage of the dial tab 208 within the dial slot 210 when jarred or bumped.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A tunable anti-glare filter for adjusting an intensity of light passing through the tunable anti-glare filter, the tunable anti-glare filter comprising:
a first polarized filter layer configured to rotate about a center axis relative to a substrate; and
a second polarized filter layer that is substantially parallel to the first polarized filter layer and that is fixed relative to the substrate,
wherein the first polarized filter layer configured to rotate between a first extreme position and a second extreme position that is shifted 90 degrees about the center axis.

2. The tunable anti-glare filter of claim 1, wherein, in the first extreme position, the intensity of the light passing through the first polarized filter layer and the second polarized filter layer is substantially unobstructed.

3. The tunable anti-glare filter of claim 1, wherein, in the second extreme position, the intensity of the light passing through the first polarized filter layer and the second polarized filter layer is substantially blocked.

4. The tunable anti-glare filter of claim 1, further comprising a retaining ring, wherein the second polarized filter layer is fixedly coupled to the substrate via the retaining ring.

5. The tunable anti-glare filter of claim 4, wherein the second polarized filter layer, the substrate, and the retaining ring define a cavity.

6. The tunable anti-glare filter of claim 5, wherein the first polarized filter layer is positioned within the cavity.

7. The tunable anti-glare filter of claim 6, wherein the first polarized filter layer further comprises a dial tab configured to pass through a dial slot formed in the second polarized filter layer.

8. The tunable anti-glare filter of claim 7, wherein the dial slot is an arcuate slot that has an arc length of 90 degrees.

9. The tunable anti-glare filter of claim 1, wherein the substrate is a layer of clear, rigid material.

10. The tunable anti-glare filter of claim 9, wherein the substrate comprises one or more fasteners to couple the tunable anti-glare filter to a vehicle.

11. The tunable anti-glare filter of claim 1, wherein the substrate is a glass component of a vehicle.

12. A tunable anti-glare filter for adjusting an intensity of light passing through the tunable anti-glare filter, the tunable anti-glare filter comprising:
a first polarized filter layer configured to rotate about a center axis relative to a substrate; and
a second polarized filter layer that is substantially parallel to the first polarized filter layer and that is fixed relative to the substrate,
wherein the first polarized filter layer configured to rotate about the center axis between
a first extreme position where the intensity of the light passing through the first polarized filter layer and the second polarized filter layer is substantially unobstructed, and
a second extreme position where the intensity of the light passing through the first polarized filter layer and the second polarized filter layer is substantially blocked.

13. The tunable anti-glare filter of claim 12, wherein the first extreme position and the second extreme position are shifted 90 degrees about the center axis.

14. The tunable anti-glare filter of claim 12, further comprising a retaining ring, wherein the second polarized filter layer is fixedly coupled to the substrate via the retaining ring.

15. The tunable anti-glare filter of claim 14, wherein the second polarized filter layer, the substrate, and the retaining ring define a cavity.

16. The tunable anti-glare filter of claim 15, wherein the first polarized filter layer is positioned within the cavity.

17. The tunable anti-glare filter of claim 16, wherein the first polarized filter layer further comprises a dial tab configured to pass through a dial slot formed in the second polarized filter layer.

18. The tunable anti-glare filter of claim 17, wherein the dial slot is an arcuate slot that has an arc length of 90 degrees.

19. A tunable anti-glare filter for adjusting an intensity of light passing through the tunable anti-glare filter, the tunable anti-glare filter comprising:
a first polarized filter layer configured to rotate about a center axis relative to a substrate; and
a second polarized filter layer that is substantially parallel to the first polarized filter layer and that is fixed relative to the substrate,
wherein the first polarized filter layer configured to rotate about the center axis between
a first extreme position where the intensity of the light passing through the first polarized filter layer and the second polarized filter layer is substantially unobstructed, and
a second extreme position where the intensity of the light passing through the first polarized filter layer and the second polarized filter layer is substantially blocked, and
wherein the first extreme position and the second extreme position are shifted 90 degrees about the center axis.

20. The tunable anti-glare filter of claim 19, wherein the first polarized filter layer is positioned within a cavity defined by the second polarized filter layer, the substrate, and a retaining ring, and wherein the first polarized filter layer further comprises a dial tab configured to pass through a dial slot formed in the second polarized filter layer.
